(19) United States
(12) Patent Application Publication
(10) Pub. No.: US 2018/0113450 A1
(43) Pub. Date: Apr. 26, 2018

(54) AUTONOMOUS-MODE TRAFFIC LANE SELECTION BASED ON TRAFFIC LANE CONGESTION LEVELS

(71) Applicant: Toyota Motor Engineering & Manufacturing North America, Inc., Erlanger, KY (US)

(72) Inventor: Rini Sherony, Ann Arbor, MI (US)

(21) Appl. No.: 15/298,239

(22) Filed: Oct. 20, 2016

(51) Int. Cl. G05D 1/00; G01C 21/36; B60W 10/20; B60W 10/04; B60W 30/095; B60W 30/18; B60W 50/14; G08G 1/16; G05D 1/02

(52) U.S. Cl. CPC G05D 1/0022; B60W 2420/42; B60W 10/20; B60W 10/04; B60W 30/0956; B60W 30/18163; B60W 50/14; G08G 1/167; G08G 1/162; G05D 1/0088; G05D 1/0219; B60W 2050/146; B60W 2720/24; B60W 2550/308; B60W 2550/40; B60W 2420/52; G01C 21/3691

(57) ABSTRACT

A method and device for an autonomous vehicle control unit for traffic lane selection are disclosed. In operation, a present traffic lane in relation to each of a plurality of traffic lanes for a roadway is identified. A traffic congestion level is determined for the each of the plurality of traffic lanes, and compared with each other to determine a lowest-congested traffic lane of the plurality of traffic lanes. When the lowest-congested traffic lane is other than the present traffic lane, a traffic lane change command is generated that includes identifier data for an adjacent traffic lane having a lower traffic congestion level. The traffic lane change command is transmitted to effect a traffic lane change of the vehicle from the present traffic lane to an adjacent traffic lane.

### BACKGROUND

Vehicle operators navigate roadways to destinations largely by intuition and their own driving experience. With vehicles capable of autonomous operation, destinations are reached on general macro-level objectives. For example, an autonomous vehicle receives data relating to an origin and a destination, and a travel route is generated for a destination objective. In operation, autonomous vehicles may function under general traffic rules, such as to stay within a traffic lane, to avoid other vehicles, to sustain a reasonable speed, etc. In congested traffic conditions, however, an autonomous vehicle may not implement traffic lane selection within a roadway to improve travel time results, other than to follow the travel route from origination to destination. It is desirable for a vehicle, in an autonomous operational mode, to provide traffic lane selection based on traffic lane congestion levels.

### SUMMARY

A device and method in an autonomous vehicle control unit for traffic lane selection based on traffic lane congestion are disclosed.

In one implementation, a method in an autonomous vehicle control unit for traffic lane selection is disclosed. In the method, a present traffic lane in relation to each of a plurality of traffic lanes for a roadway is identified. A traffic congestion level is determined for the each of the plurality of traffic lanes, and compared with each other to determine a lowest-congested traffic lane of the plurality of traffic lanes. When the lowest-congested traffic lane is other than the present traffic lane, a traffic lane change command is generated that includes identifier data for an adjacent traffic lane having a lower traffic congestion level. The traffic lane change command is transmitted to effect a traffic lane change from the present traffic lane to the adjacent traffic lane.

In another implementation, a vehicle control unit for traffic lane selection is disclosed. The vehicle control unit includes a wireless communication interface, a processor, and a memory. The wireless communication interface is operable to service communication with a vehicle network and user equipment of a vehicle user. The processor is coupled to the wireless communication interface, and is for controlling operations of the vehicle control unit. The memory is coupled to the processor, and is for storing data and program instructions used by the processor. The processor is configured to execute instructions stored in the memory to identify a present traffic lane in relation to each of a plurality of traffic lanes for a roadway. A traffic congestion level is determined for the each of the plurality of traffic lanes, and compared with each other to determine a lowest-congested traffic lane of the plurality of traffic lanes. When the lowest-congested traffic lane is other than the present traffic lane, a traffic lane change command is generated that includes identifier data for an adjacent traffic lane having a lower traffic congestion level. The traffic lane change command is transmitted to effect a traffic lane change from the present traffic lane to the adjacent traffic lane.

### BRIEF DESCRIPTION OF THE DRAWINGS

The description makes reference to the accompanying drawings wherein like reference numerals refer to like parts throughout the several views, and wherein:

FIG. 1 is a schematic illustration of a vehicle including a vehicle control unit;

FIG. 2 shows a block diagram of a vehicle control unit of FIG. 1 in the context of a vehicle network environment;

FIG. 3 shows a block diagram of the vehicle control unit of FIG. 1;

FIG. 4 illustrates a top view example of the autonomous vehicle of FIG. 1 in relation to a roadway having multiple traffic lanes;

FIG. 5A illustrates a vector data representation of the autonomous vehicle of FIG. 1 with respect to sensing a distance to other vehicles;

FIG. 5B illustrates a Cartesian data representation of the vectors of FIG. 5A;

FIG. 6 illustrates another example of traffic lane selection by the vehicle control unit of the vehicle of FIG. 1; and

FIG. 7 is an example process of traffic lane selection based on traffic lane congestion levels.

### DETAILED DESCRIPTION

A device and method autonomous-mode traffic lane selection based on traffic lane congestion levels are disclosed.

As may be appreciated, roadways are generally designed for given amount of traffic capacity. Slower speeds, longer trip times, and increased vehicular queuing may result as roadway congestion increases. As the amount of vehicles approach capacity and/or a bandwidth of the roadway, excessive traffic congestion may occur, where vehicles are fully stopped for periods of time. Generally, drivers and/or operators may become increasingly frustrated, and at the extreme, road rage may result.

Traffic congestion generally occurs when traffic volume generates a demand for space greater than the available roadway capacity and/or bandwidth, which may also be referred to as saturation. Circumstances that may aggravate traffic congestion may include reducing the capacity of a roadway at a given point or over a certain length (such as by a traffic incident), by increasing the number of vehicles required for a given volume of people or goods, etc.

Another circumstance that may aggravate traffic congestion is when vehicles are not sufficiently distributed across a multi-lane roadway. Human operators may intuitively distribute the number of vehicles across the lanes of a roadway by seeking a lane having the greatest speed relative to the other lanes. Such lanes may be identifiable by having a greater distance from a present vehicle to a vehicle ahead in another lane. Accordingly, intuitively, a vehicle driven by a human will seek out the lane having fewer vehicles, effectively distributing the vehicles across the roadway, and resulting in lesser roadway congestion.

On the other hand, an autonomous vehicle may have a general overview of a travel route being the quickest to a destination as compared to other travel route options causing traffic congestion. But an autonomous vehicle may not actively seek out a lowest-congested traffic lane when traffic congestion does occur. Based on autonomous operational rules, the autonomous vehicle may use an array of sensors, lasers, radar, cameras, and global positioning satellite (GPS) technology to analyze the vehicle's surroundings, and maneuver to at least lower-congested traffic lanes as compared to a present traffic lane.

In one example method, traffic lane selection is provided for a roadway having a plurality of traffic lanes in a common direction of travel. An autonomous vehicle control unit identifies a present traffic lane of the instant vehicle in relation to each of the traffic lanes, and determines a traffic congestion level for each traffic lane. With a traffic congestion level for each of traffic lanes, the autonomous vehicle control unit may compare the traffic congestion level for each of the traffic lanes to determine a lowest-congested traffic lane. When the lowest-congested traffic lane is other than the present traffic lane, the autonomous vehicle control unit generates a traffic lane change command, which may include identifier data for an adjacent traffic lane having a lower traffic congestion level to the present traffic lane. The autonomous vehicle control unit transmits the traffic lane change command to effect a traffic lane change from the present traffic lane to the adjacent traffic lane.

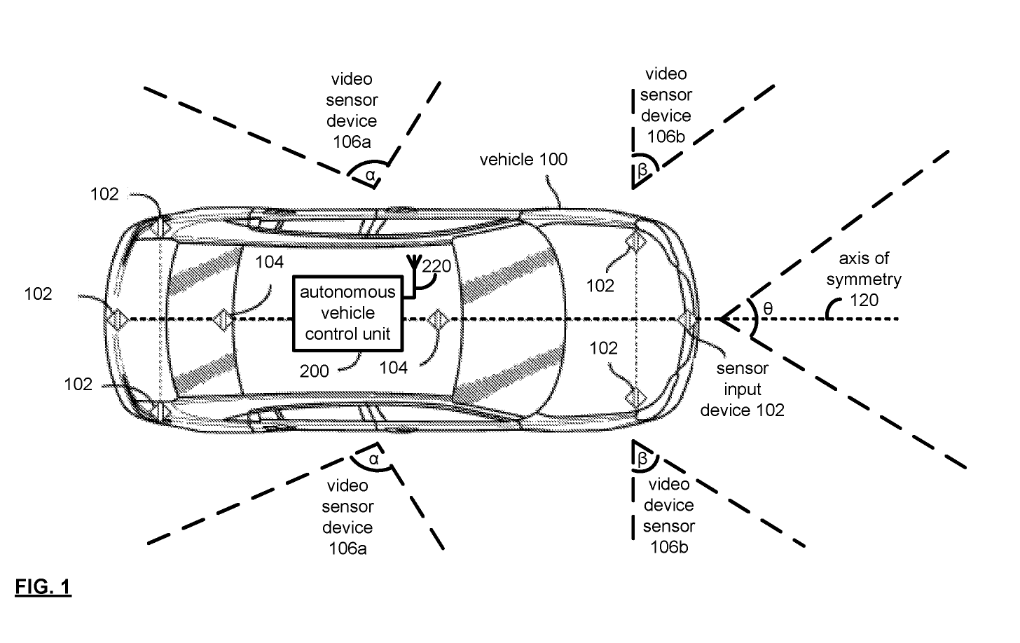

FIG. 1 is a schematic illustration of a vehicle 100 including an autonomous vehicle control unit 200. A plurality of sensor devices 102, 104 and 106 are in communication with the control unit 200. The plurality of sensor devices 102, 104 and 106 can be positioned on the outer surface of the vehicle 100, or may be positioned in a concealed fashion for aesthetic purposes with regard to the vehicle. Moreover, the sensors may operate at frequencies in which the vehicle body or portions thereof appear transparent to the respective sensor device. Communication between the sensors may be on a bus basis and may also be used or operated by other systems of the vehicle 100. For example, the sensors 102, 104 and 106 may be coupled by a combination of network architectures such as a Body Electronic Area Network (BEAN), a Controller Area Network (CAN) bus configuration, an Audio Visual Communication-Local Area Network (AVC-LAN) configuration, an automotive Ethernet LAN and/or automotive Wireless LAN configuration, and/or other combinations of additional communication-system architectures to provide communications between devices and systems of the vehicle 100.

The sensor devices 102, 104 and 106 operate to monitor local conditions relating to the vehicle 100, including audio, visual, and tactile changes to the vehicle environment. The sensor devices in include sensor input devices 102, audible sensor devices 104, and video sensor devices 106a and 106b.

The sensor input devices 102 provide tactile or relational changes in the ambient conditions of the vehicle, such as a person, object, vehicle(s), etc. The one or more of the sensor input devices 102 can be configured to capture changes in velocity, acceleration, and/or distance to these objects in the ambient conditions of the vehicle 100, as well as the angle of approach, based on an axis of symmetry 120 for the vehicle.

Each of the sensor input devices 102 may include operational parameters relating to a distance range or sensitivity, and a three-dimensional (or two-dimensional) field-of-view of angle-θ, as indicated with respect to the forward sensor input device 102. The sensor input devices 102 may be provided by a Light Detection and Ranging (LIDAR) system, in which the sensor input devices 102 may capture data related to laser light returns from physical objects in the environment of the vehicle 100. Because light moves at a constant speed, LIDAR may be used to determine a distance between the sensor input device 102 and another object with a high degree of accuracy. Also, measurements take into consideration movement of the sensor input device 102 (such as sensor height, location and orientation). Also, GPS location may be used for each of the sensor input devices 102 for determining respective sensor movement. The sensor input devices 102 may also be implemented by milliwave radar devices. Also, as may be further appreciated, the sensor input devices 102 may implement video sensor devices in the visible and/or non-visible light spectrums to capture and render image recognition and depth perception data capabilities as such devices increase with image sensitivity, and decrease with data capture latency.

The audible sensor devices 104 provide audible sensing of the ambient conditions of the vehicle. With speech recognition capability, the audible sensor devices 104 may receive instructions to move, or to receive other such directions. The audible sensor devices 104 may be provided, for example, by a nano-electromechanical system (NEMS) or micro-electromechanical system (MEMS) audio sensor omnidirectional digital microphone, a sound-triggered digital microphone, etc.

The video sensor devices 106a and 106b include associated fields of view. For the example of FIG. 1, the video sensor device 106a has a three-dimensional (or two-dimensional) field-of-view of angle-α, and the video sensor device 106b has a three-dimensional dimensional field-of-view of angle-β, with each video sensor device having a sensor range for video detection.

In the various driving modes, the examples of the placement of the video sensor devices 106a for blind-spot visual sensing (such as for another vehicle adjacent the vehicle 100) relative to the vehicle user, and the video sensor devices 106b are positioned for forward periphery visual sensing (such as for objects outside the forward view of a vehicle user, such as a pedestrian, cyclist, etc.).

In autonomous parking operations directed by the autonomous vehicle control unit 200, the video sensor devices 106a and 106b may be further deployed to read lane markings and determine vehicle positions with the road to facilitate the relocation of the vehicle 100.

For controlling data input from the sensor devices 102, 104 and 106, the respective sensitivity and focus of each of the sensor devices may be dynamically adjusted to limit data acquisition based upon speed, terrain, activity around the vehicle, etc.

For example, though the field-of-view angles of the video sensor devices 106a and 106b, and sensor input device 102 as may be implemented, can be in a fixed relation to the vehicle 100, and/or may be adaptively increased and/or decreased based upon the vehicle's driving mode, such as a highway driving mode to take in less of the ambient conditions in view of the more rapidly changing conditions relative to the vehicle 100, a residential driving mode to take in more of the ambient conditions that may change rapidly (such as a child's ball crossing in front of the vehicle, etc.), a parking mode in which a full field-of-view may be used to increase a sensitivity towards changes in ambient conditions relative to the vehicle 100, with the sensitivity extended further to realize changes in traffic congestion levels about the vehicle.

Also, some of the sensor devices may be effectively blocked depending upon the driving mode of the vehicle 100. For example, when the vehicle 100 is traveling at highway, or even residential, speeds, the audible sensor devices 104 simply detect white noise from the air moving across the microphone pick-up and may not be sufficiently filtered to remove the extraneous data input. In such instances, the input from the audible sensor devices 104 may be switched to an off or a sleep mode until the vehicle 100 returns to a lower rate of speed.

The vehicle 100 can also include options for operating in manual mode, autonomous mode, and/or driver-assist mode. When the vehicle 100 is in manual mode, the driver manually controls the vehicle systems, which may include a propulsion system, a steering system, a stability control system, a navigation system, an energy system, and any other systems that can control various vehicle functions (such as the vehicle climate or entertainment functions, etc.). The vehicle 100 can also include interfaces for the driver to interact with the vehicle systems, for example, one or more interactive displays, audio systems, voice recognition systems, buttons and/or dials, haptic feedback systems, or any other means for inputting or outputting information.

In autonomous mode of operation, a computing device, which may be provided by the autonomous vehicle control unit 200, or in combination therewith, can be used to control one or more of the vehicle systems without the vehicle user's direct intervention. Some vehicles may also be equipped with a “driver-assist mode,” in which operation of the vehicle 100 can be shared between the vehicle user and a computing device.

For example, the vehicle user can control certain aspects of the vehicle operation, such as steering, while the computing device can control other aspects of the vehicle operation, such as braking and acceleration. When the vehicle 100 is operating in autonomous (or driver-assist) mode, the autonomous vehicle control unit 200 issues commands to the various vehicle systems to direct their operation, rather than such vehicle systems being controlled by the vehicle user.

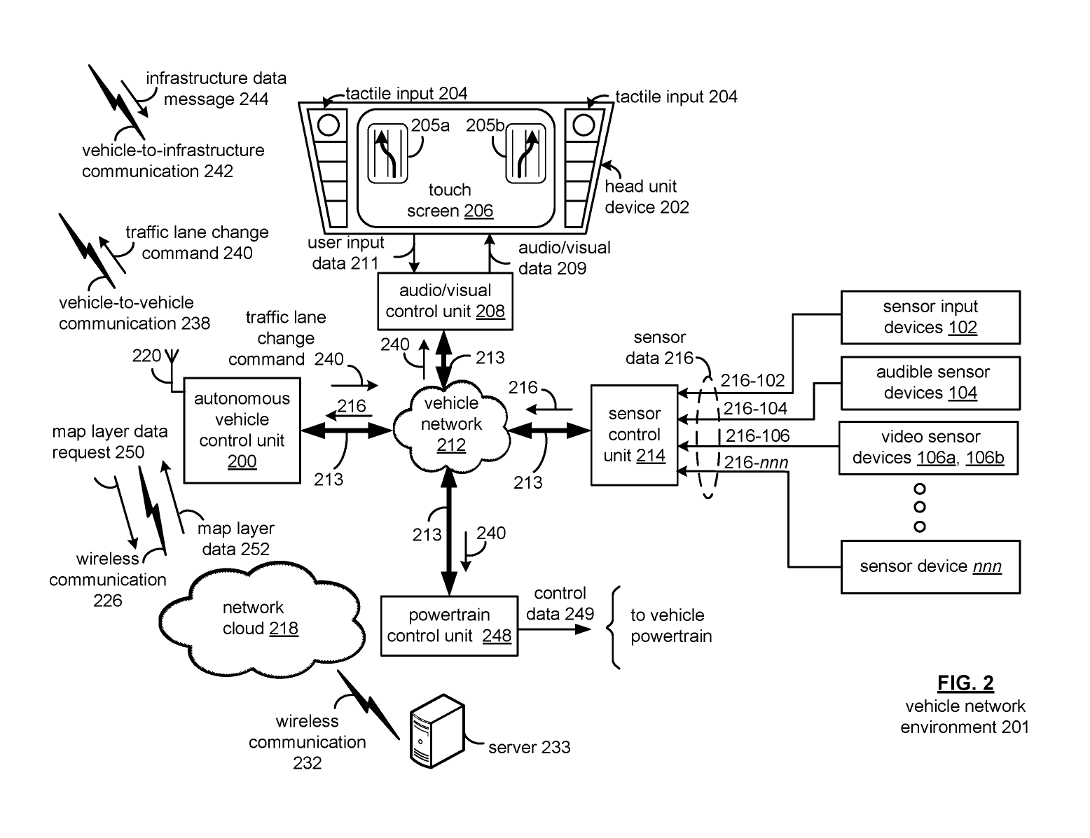

As shown in FIG. 1, the autonomous vehicle control unit 200 is configured to provide wireless communication with a user device through the antenna 220, other vehicles (vehicle-to-vehicle), and/or infrastructure (vehicle-to-infrastructure), which is discussed in detail with respect to FIGS. 2-7.

Referring now to FIG. 2, a block diagram of an autonomous vehicle control unit 200 in the context of a vehicle network environment 201 is provided. While the autonomous vehicle control unit 200 is depicted in abstract with other vehicular components, the vehicle control unit 200 may be combined with the system components of the vehicle 100 (see FIG. 1). Moreover, the vehicle 100 may also be an automobile or any other passenger or non-passenger vehicle such as, for example, a terrestrial, aquatic, and/or airborne vehicle.

As shown in FIG. 2, the autonomous vehicle control unit 200 communicates with a head unit device 202 via a communication path 213, and may also be wirelessly coupled with a network cloud 218 via the antenna 220 and wireless communication 226. From network cloud 218, a wireless communication 232 provides communication access to a server 233. The autonomous vehicle control unit 200 is operable to retrieve location data for the vehicle 100, via a global positioning satellite (GPS) data, and generate a request 250, based on the location data, for map layer data via the server 233. The autonomous vehicle control unit 200 may receive, in response to the request 250, map layer data 252. The autonomous vehicle control unit 200 may then determine from the map layer data 252 a general present traffic speed for the roadway relative to a free-flowing traffic speed.

Moreover, handheld mobile devices may also be communicatively coupled to the vehicle network 212 via wireless communication 226 and network cloud 218, such as a handheld mobile device (for example, cell phone, a smart phone, a personal digital assistant (PDA) devices, tablet computer, e-readers, etc.).

As may also be appreciated, the antenna 220 operates to provide communications with the autonomous vehicle control unit 200 through vehicle-to-vehicle communications 238, through vehicle-to-infrastructure communications 242, and wireless communication 226.

In vehicle-to-vehicle communication 238, the vehicle 100 may message another vehicle, and the another vehicle may message the vehicle 100 through dedicated short-range radio communications to exchange messages. In the example provided by FIG. 2, the vehicle-to-vehicle communication 238 provides and/or broadcasts vehicle maneuver information, such as lane changes (e.g., traffic lane change command 240), speed increases, sudden stops, excessive slowing due to congestion brought on by excessive traffic, traffic signals, accidents, etc. Moreover, the vehicle-to-vehicle communications 238 may be in the form of a chain message that can be passed wirelessly by other vehicles. In effect, the autonomous vehicle control unit 200 may receive advance notice, or indication, of a change in traffic congestion while on approach.

Vehicle-to-infrastructure communications 242 may operate to broadcast traffic stoppage points, such as a traffic light or a traffic sign, and provide advance indication to the autonomous vehicle control unit 200 of the likelihood of oncoming traffic congestion, as well as beacons and/or vehicle-to-infrastructure devices operable to gather local traffic information and local traffic congestion, and broadcast the gathered data. An infrastructure data message 244 may include message data relating and/or indicating increasing traffic congestion levels such as red light violation warning data, curve speed warning data, stop sign gap assist data, reduced speed zone warning data, stop sign violation warning data, and railroad crossing violation warning data.

Through the sensor control unit 214, the autonomous vehicle control unit 200 may access sensor data 216-102 of the sensor input device 102, sensor data 216-104 of the audible sensor device 104, sensor data 216-106 of the video sensor device 106, and additional useful sensor data 216-nnn of the sensor device nnn, as further technologies and configurations may become available.

The sensor data 216 operates to permit vehicle detection external to the vehicle, such as for example, other vehicles ahead of the vehicle 100, as well as roadway obstacles, traffic signals, signs, trees, etc. Accordingly, the sensor data 216 allow the vehicle 100 (see FIG. 1) to assess its environment in order to maximize safety for vehicle passengers and objects and/or people in the environment.

With the sensor data 216, the autonomous vehicle control unit 200 may operate to identify a present traffic lane in relation to a plurality of traffic lanes, and determine a traffic congestion level of each of the traffic lanes, which relates to traffic flow (or relative speed) among each traffic lane, as well as a traffic congestion condition for the roadway. With the respective traffic congestion level for each of the traffic lanes, including adjacent and present traffic lanes, the autonomous vehicle control unit 200 operates to compare the traffic congestion level for each of the plurality of traffic lanes to determine a lowest-congested traffic lane of the lanes.

When the lowest-contest traffic lane of the traffic lanes is other than the present traffic lane, the autonomous vehicle control unit 200 generates a traffic lane change command 240. The traffic lane change command 240 may include identifier data for an adjacent traffic lane having a lower traffic congestion level. The autonomous vehicle control unit 200 may transmit the traffic lane change command 240 to effect the traffic lane change from the present traffic lane to an adjacent traffic lane.

The autonomous vehicle control unit 200 may transmit the traffic lane change command 240 via the vehicle network 212 through the communication path(es) 213 to audio/visual control unit 208, to the powertrain control unit 248, etc. The powertrain control unit 248 operates to produce control data 249 based on the traffic lane change command 240, to transmit to vehicle powertrain actuators.

The term “powertrain” as used herein describes vehicle components that generate power and deliver the power to the road surface, water, or air. The powertrain may include the engine, transmission, drive shafts, differentials, and the final drive communicating the power to motion (for example, drive wheels, continuous track as in military tanks or caterpillar tractors, propeller, etc.). Also, the powertrain may include steering wheel angle control, either through a physical steering wheel of the vehicle 100, or via drive-by-wire and/or drive-by-light actuators.

Still referring to FIG. 2, the head unit device 202 includes, for example, tactile input 204 and a touch screen 206. The touch screen 206 operates to provide visual output or graphic user interfaces such as, for example, maps, navigation, entertainment, information, infotainment, and/or combinations thereof. For example, when the autonomous vehicle control unit 200 generates a traffic lane change command 240, the audio/visual control unit 208 may generate audio/visual data 209 that displays either of the lane change icons 205a or 205b based on the direction of the lane change. In this manner, the operator and/or passenger of a vehicle, which may be operating autonomously, announce the actions being undertaken, limiting the anxiety of the vehicle occupants.

The touch screen 206 may include mediums capable of transmitting an optical and/or visual output such as, for example, a cathode ray tube, light emitting diodes, a liquid crystal display, a plasma display, etc. Moreover, the touch screen 206 may, in addition to providing visual information, detect the presence and location of a tactile input upon a surface of or adjacent to the display. Accordingly, the display may receive mechanical input directly upon the visual output provided by the touch screen 206. Additionally, it is noted that the touch screen 206 can include at least one or more processors and one or more memory modules. Touch screen 206 may include a display screen, such as a liquid crystal display (LCD), light emitting diode (LED), plasma display or other two dimensional or three dimensional display that displays graphics, text or video in either monochrome or color in response to display data audio/visual data 209.

The head unit device 202 may also include tactile input and/or control inputs such that the communication path 213 communicatively couples the tactile input to other control units and/or modules of the vehicle 100 (see FIG. 1). Tactile input data may provided by devices capable of transforming mechanical, optical, or electrical signals into a data signal capable of being transmitted via the communication path 213. The tactile input 204 may include number of movable objects that each transform physical motion into a data signal that can be transmitted over the communication path 213 such as, for example, a button, a switch, a knob, a microphone, etc.

The touch screen 206 and the tactile input 204 may be combined as a single module, and may operate as an audio head unit or an infotainment system of the vehicle 100. The touch screen 206 and the tactile input 204 can be separate from one another and operate as a single module by exchanging signals via the communication path 104.

As may be appreciated, the communication path 213 of the vehicle network 212 may be formed a medium suitable for transmitting a signal such as, for example, conductive wires, conductive traces, optical waveguides, or the like. Moreover, the communication path 213 can be formed from a combination of mediums capable of transmitting signals. In one embodiment, the communication path 213 can comprise a combination of conductive traces, conductive wires, connectors, and buses that cooperate to permit the transmission of electrical data signals to components such as processors, memories, sensors, input devices, output devices, and communication devices. Accordingly, the communication path 213 may be provided by a vehicle bus, or combinations thereof, such as for example, a Body Electronic Area Network (BEAN), a Controller Area Network (CAN) bus configuration, an Audio Visual Communication-Local Area Network (AVC-LAN) configuration, a Local Interconnect Network (LIN) configuration, a Vehicle Area Network (VAN) bus, a vehicle Ethernet LAN, a vehicle wireless LAN and/or other combinations of additional communication-system architectures to provide communications between devices and systems of the vehicle 100.

The term “signal” relates to a waveform (e.g., electrical, optical, magnetic, mechanical or electromagnetic), such as DC, AC, sinusoidal-wave, triangular-wave, square-wave, vibration, and the like, capable of traveling through at least some of the mediums described herein.

The vehicle network 212 may be communicatively coupled to receive signals from global positioning system satellites, such as via the antenna 220 of the autonomous vehicle control unit 200, or other such vehicle antenna (not shown). The antenna 220 may include one or more conductive elements that interact with electromagnetic signals transmitted by global positioning system satellites. The received signals may be transformed into a data signal indicative of the location (for example, latitude and longitude positions), and further indicative of the positioning of the vehicle with respect to road data, in which a vehicle position can be indicated on a map displayed via the touch screen 206.

The wireless communication 226, 232, 238 and 242 may be based on one or many wireless communication system specifications. For example, wireless communication systems may operate in accordance with one or more standards specifications including, but not limited to, 3GPP (3rd Generation Partnership Project), 4GPP (4th Generation Partnership Project), SGPP (5th Generation Partnership Project), LTE (long term evolution), LTE Advanced, RFID, IEEE 802.11, Bluetooth, AMPS (advanced mobile phone services), digital AMPS, GSM (global system for mobile communications), CDMA (code division multiple access), LMDS (local multi-point distribution systems), MMDS (multi-channel-multi-point distribution systems), IrDA, Wireless USB, Z-Wave, ZigBee, and/or variations thereof.

The autonomous vehicle control unit 200 may be communicatively coupled to a computer 224 via wireless communication 228, a handheld mobile device 222 via wireless communication 230, etc. As described in more detail below, application data may be provided to the vehicle control unit 200 from various applications running and/or executing on wireless platforms of the computer 224 and the handheld mobile device 222, as well as from a navigation application of the head unit device 202 via the vehicle network 212.

The handheld mobile device 222 and/or computer 224, by way of example, may be a device including hardware (for example, chipsets, processors, memory, etc.) for communicatively coupling with the network cloud 218, and also include an antenna for communicating over one or more of the wireless computer networks described herein.

Also, in reference to FIG. 2, a server 233 may be communicatively coupled to the network cloud 218 via wireless communication 232. The server 233 may include third party servers that are associated with applications that running and/or executed on the head unit device 202, etc. For example, map data layers may be executing on the head unit device 202 and further include GPS location data to identify the location of the vehicle 100 in a graphic map display.

The server 233 may be operated by an organization that provides the application, such as a mapping application and map application layer data including roadway information data, traffic layer data, geolocation layer data, etc. Layer data may be provided in a Route Network Description File (RNDF) format. A Route Network Description File specifies, for example, accessible road segments and provides information such as waypoints, stop sign locations, lane widths, checkpoint locations, and parking spot locations. The route network has no implied start or end point. Servers such as server 233 may also provide data as Mission Description Files (MDF) for autonomous vehicle operation. A Mission Description Files (MDF) may operate to specify checkpoints to reach in a mission, such as along a travel route. It should be understood that the devices discussed herein may be communicatively coupled to a number of servers by way of the network cloud 218.

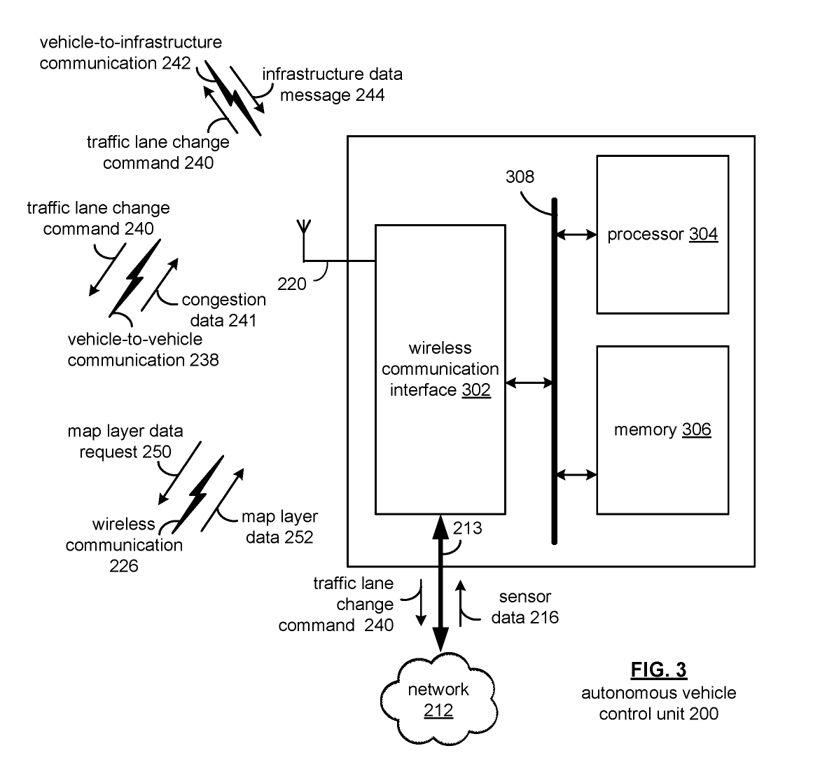

FIG. 3 is a block diagram of an autonomous vehicle control unit 200, which includes a wireless communication interface 302, a processor 304, and memory 306, that are communicatively coupled via a bus 308.

The processor 304 in the control unit 200 can be a conventional central processing unit or any other type of device, or multiple devices, capable of manipulating or processing information. As may be appreciated, processor 304 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions.

The memory and/or memory element 306 may be a single memory device, a plurality of memory devices, and/or embedded circuitry of the processor 304. Such a memory device may be a read-only memory, random access memory, volatile memory, non-volatile memory, static memory, dynamic memory, flash memory, cache memory, and/or any device that stores digital information. The memory 306 is capable of storing machine readable instructions such that the machine readable instructions can be accessed by the processor 304. The machine readable instructions can comprise logic or algorithm(s) written in programming languages, and generations thereof, (e.g., 1GL, 2GL, 3GL, 4GL, or 5GL) such as, for example, machine language that may be directly executed by the processor 304, or assembly language, object-oriented programming (OOP), scripting languages, microcode, etc., that may be compiled or assembled into machine readable instructions and stored on the memory 306. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods and devices described herein may be implemented in any conventional computer programming language, as pre-programmed hardware elements, or as a combination of hardware and software components.

Note that when the processor 304 includes more than one processing device, the processing devices may be centrally located (e.g., directly coupled together via a wired and/or wireless bus structure) or may be distributed located (e.g., cloud computing via indirect coupling via a local area network and/or a wide area network). Further note that when the processor 304 implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element stores, and the processor 304 executes, hard coded and/or operational instructions corresponding to at least some of the steps and/or functions illustrated in FIGS. 1-7 to perform autonomous traffic lane selection features and methods described herein.

The wireless communication interface 302 generally governs and manages the vehicle user input data via the network 212 over the communication path 213 and/or wireless communication 226, 238 and/or 248. The wireless communication interface 302 also manages controller unit output data such as the traffic lane change command 240, sensor data 216, and data requests, such as map layer data request 250, and also manages control unit input data, such as an infrastructure data message 244, congestion data 241, and map layer data 252. There is no restriction on the present disclosure operating on any particular hardware arrangement and therefore the basic features herein may be substituted, removed, added to, or otherwise modified for improved hardware and/or firmware arrangements as they may develop.

The sensor data 216 includes capturing of intensity or reflectivity returns of the environment surrounding the vehicle, and relative distance of vehicles. In general, data captured by the sensor devices 102, 104 and/or 106, and provided to the autonomous vehicle control unit 200 via the communication path 213, can be used by one or more of applications of the vehicle to determine the environment surroundings of the vehicle, and to also sense positional accuracy to improve vehicle distance determinations with other vehicles or objects.

The autonomous vehicle control unit 200 functions to determine a traffic congestion condition for a roadway. The traffic congestion condition may be based on traffic map layer data 252 received via the wireless communication 226, based on congestion data 241 from other vehicles via the vehicle-to-vehicle communication 238, based on data through the infrastructure data message 244 via the vehicle-to-infrastructure communication 242, based on vehicle sensor data, and/or a combination thereof.

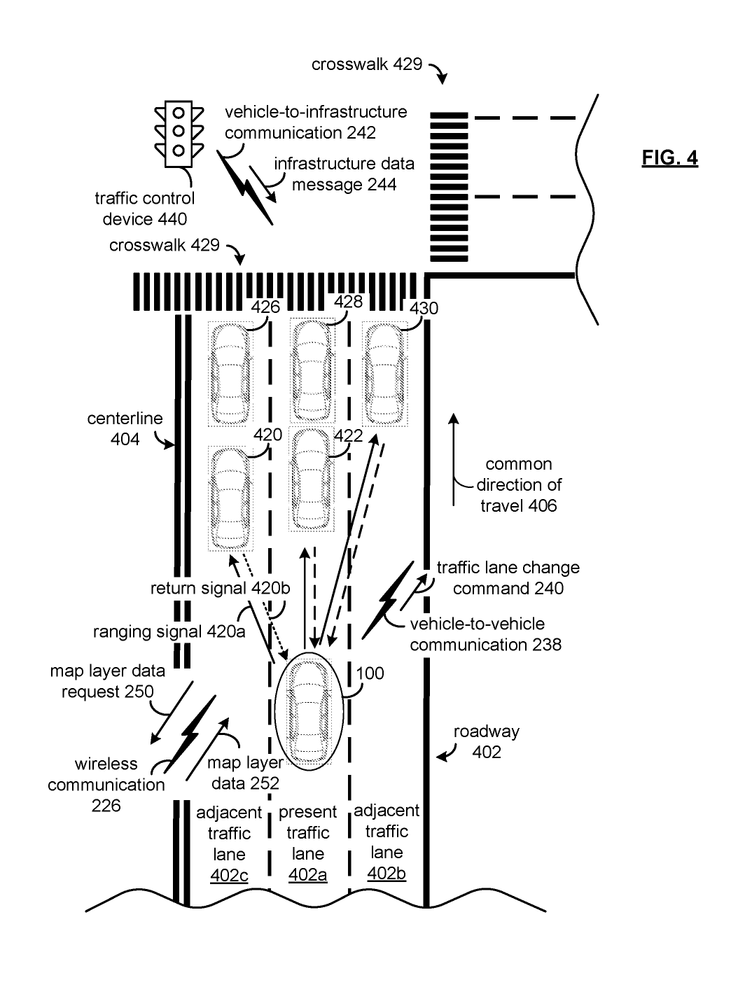

When the traffic congestion condition exceeds a threshold, such as the amount vehicle speed in general has fallen with respect to a designated roadway speed limit or a free-flowing traffic speed. For example, map layer data 252 may be based on crowd-sourced basis, in which GPS based locations of roadway users are provided by their respective handheld mobile devices (via on-board GPS devices). The general movement and/or speed of the handheld mobile devices indicate the traffic flow of a roadway, and may be visually depicted as a map layer and displayed to the head unit device 202. As an example, a colored overlay appears on top of major roads and motorways, with green representing a normal traffic flow, yellow representing slower traffic conditions, red indicating congestion, and dark red indicating nearly stopped or stop-and-go traffic for a roadway. The underlying data values may be used by the autonomous vehicle control unit 200 to determine roadway congestion, and threshold value may be utilized to determine the extent of a traffic congestion condition and whether the autonomous vehicle control unit 200 prompts changing to a lowest, or less, congested lane, as is discussed in detail with reference to FIGS. 4-7.

FIG. 4 illustrates a top view of a vehicle 100 in relation to a roadway 402. A roadway may be understood to include a part of a road intended for vehicular traffic, as contrasted to a sidewalk, median, pedestrian pathways, etc. In the example of FIG. 4, vehicular traffic may include passenger cars, passenger trucks, semi-trucks, cargo vans, emergency or first response vehicles, transport vehicles, etc. As may be appreciated by one of skill in the art, a roadway may include avenues, boulevards, bypasses, causeways, divided highways, expressways, freeways, feeders, frontage roads, highways, interstates, toll roads and/or tollways, turnpikes, one-way and/or two-way streets, etc.

The roadway 402 includes traffic lanes 402a, 402b, and 402c having a common direction of travel 406, as also may be indicated by centerline 404 for the roadway 402. As may be appreciated, additional or fewer lanes may be present.

In the example of FIG. 4, traffic lanes are identified as present traffic lane 402a, which identifies a present traffic lane for vehicle 100. Adjacent lanes to the present traffic lane 402a are identified as adjacent traffic lane 402b to the passenger side of the vehicle 100, and adjacent traffic lane 402c to the driver side of vehicle 100. In this manner, various lanes are available for operation of the vehicle 100.

In an autonomous mode of operation, the vehicle 100 may operate in a middle lane with respect to the other lanes of the roadway 402 to provide to provide a smoother travel experience for a passenger on a longer leg of a travel route. The vehicle 100 may operate in other lanes to facilitate expected course changes in the travel route (such as to turn right or left to begin another leg of a travel route). Accordingly, the embodiments of the device and method disclosed may be used while in either of the lanes of a roadway 402. The lane that the vehicle 100 occupies may be considered a present traffic lane with respect to other lanes of the roadway 402.

The roadway 402 includes a traffic control device 440 to control traffic flow for the roadway 402 at a demarcation point, such as crosswalk 429. Traffic control devices may include street signs, traffic signals, road markings, etc. These signs, signals, and stripes may guide drivers and/or autonomous vehicles in navigation and control. With respect to a causal connection between traffic control devices and traffic congestion, a traffic control device 440 and stop signs may generate a larger degree of traffic congestion because of the understanding that traffic flow is to come to a stop. With a traffic control device 440, the stoppage period is timed, and as may be appreciated, a stop sign at the instance a vehicle encounters the sign. Other signage may produce congestion, such as rail road crossing signage (indicating caution), or diamond-shapes signs, that generally may indicate ordinary danger conditions call for precaution (such as yellow construction signage, dangerous curves, etc.).

Referring still to FIG. 4, the example traffic flow includes vehicle 100, and other vehicles 420, 422, 426, 428 and 430. As may be appreciated, additional or fewer vehicles may be present on a roadway.

In operation, the vehicle control unit of the vehicle 100 determines a traffic congestion condition for the roadway 402. The traffic congestion condition may be determined on various bases. For example, map layer data 252, received in response to a map layer data request 250, may be used to determine a congestion level on the traffic flow for the roadway 402. Also, the vehicle control unit of the vehicle 100 may monitor a volume of communication via the vehicle-to-vehicle communication 238. Generally, the communication volume may increase when traffic flow conditions change, such as slowing to stop when traffic control device 440 visually and/or wirelessly broadcasts a “stop” indication, or when avoiding roadway debris, or when encountering some other road event requiring caution. Also, the vehicle control unit of the vehicle 100 may receive an infrastructure data message 244 via the vehicle-to-infrastructure communication 242 from the traffic control device 440 indicating a stop, or transition to stop, command to the traffic flow of the roadway 402.

When the traffic congestion condition exceeds a threshold, such as approaching a stopped condition due to a traffic control device, the vehicle control unit of the vehicle 100 determines whether the roadway includes multiple traffic lanes with travel in a uniform travel direction. That is, with a single lane of traffic, congestion may be present, but a vehicle 100 has no options relating to changing lanes. With multiple traffic lanes, the vehicle 100 has several options to change lanes to a less, or lowest, traffic lane.

The vehicle control unit may determine whether a roadway includes multiple traffic lanes based on sensor input, map layer data, vehicle-to-infrastructure data, etc.

With respect to sensing by sensor input devices 102, the vehicle control unit receives vehicle sensor data, and determine roadway features based on the vehicle sensor data. With the roadway features, the vehicle control unit may infer more than one traffic lane, and generate an initial estimate of traffic lane geometry.

Generally, for improving traffic flow, vehicles may be distributed in a generally equal density across a roadway. In this manner, a “bandwidth” of capacity of the roadway 402 may be placed at the best and optimal usage. When the vehicle distribution is not reallocated when vehicles come into or leave the roadway flow, the vehicles may be distributed across the lanes to make effective use of the given capacity and/or bandwidth of the roadway 402.

When congestion conditions occur, the roadway distribution may be assessed and the vehicle control unit of the vehicle 100 may determine lower, or lowest, congestion levels for each of the traffic lanes 402a, 402b, and 402c of the present example. With multiple traffic lanes, the vehicle control unit of vehicle 100 identifies a present traffic lane 402a of the vehicle 100 in relation to each of the adjacent traffic lanes 402b and 402c.

The vehicle control unit of the vehicle 100 may operate to determine a traffic congestion level for each of the traffic lanes 402a, 402b and 402c. On example process to determine a traffic congestion level for a traffic lane may be based on a longitudinal distance from the vehicle 100 to each vehicle ahead in the respective traffic lane. For the example of FIG. 4, vehicle 420 is ahead of vehicle 100 for adjacent traffic lane 402c. Vehicle 422 is ahead of vehicle 100 for present traffic lane 402a. Vehicle 130 is ahead of vehicle 100 for adjacent traffic lane 402b.

For vehicles 420, 422, and 300, the vehicle 100 may be operable to sense a distance vector for each vehicle through sensor input devices 102 (see, e.g., FIG. 1) by sending a ranging signal and receiving in response a return signal. In general, a congestion level for a traffic lane may be discerned from the relative distance from the vehicle 100 to the target vehicle, which in the present example are vehicles 420, 422 and 430. The relationship may be understood that the congestion level increases as the distance between vehicles decrease. Accordingly, a lower congestion level may be indicated by a greater distance relative to the vehicle 100. In other words, congestion level of a traffic lane is inversely proportional to the distance from the vehicle 100 (that is, relative to the vehicle 100).

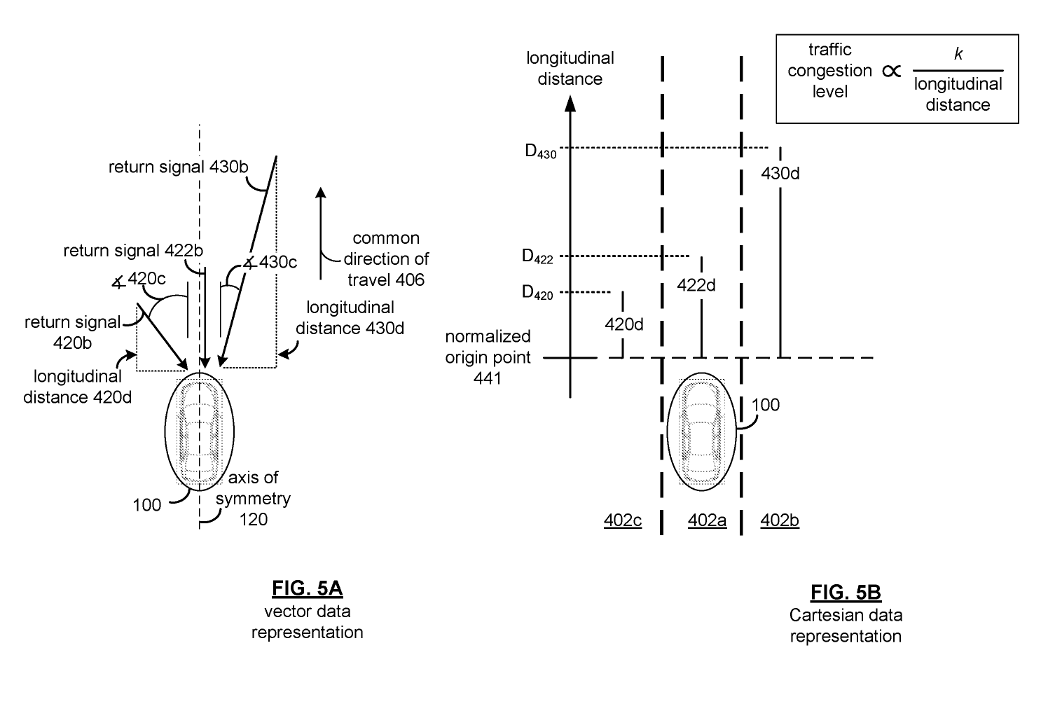

For distance determination with vehicle 420, the vehicle 100 transmits a ranging signal 420a, and receives in response a return signal 420b. Based on the return signal 420b, the vehicle control unit of the vehicle 100 may determine a longitudinal distance to the vehicle 420, as is discussed in detail with respect to FIGS. 5A and 5B. As also may be appreciated, all or some of the vehicles 420 422, and 430 may be capable of transmitting respective ranging information to the vehicle 100 via the vehicle-to-vehicle communication 238.

In the example provided, the adjacent traffic lane 402b is the lowest-congested traffic lane as compared to traffic lanes 402a and 402c. When the lowest-congested traffic lane is other than the present traffic lane 402a, the vehicle 100 may operate to traverse to the lowest-congest traffic lane by generating a traffic lane change command 240, which may include identifier data for adjacent traffic lane 402b having the lower traffic congestion level, and transmitting the traffic lane change command 240 to effect the traffic lane change. In the instant example, the vehicle control unit of the vehicle operates to effect a traffic lane change to the adjacent traffic lane 402b.

As may be appreciated, the vehicle 100 may broadcast and/or announce the traffic lane change command generally so that other vehicles may be aware of the maneuver that the vehicle 100 may undertake. FIG. 5A illustrates a vector data representation of the vehicle 100 with respect to sensing a distance to vehicles 420, 422, and 430 of FIG. 4. Based on respective sounding range signals 420a, 422a and 430a, vectors are generated by return signals 420b, 422b and 430b. With respect to an axis of symmetry 120 for the vehicle 100 provide a reference for the return signals 420b, 422b and 430b. The return signal 420b has a corresponding vector angle 420c, return signal 430b has a corresponding vector angle 430c, and return signal 422b has a corresponding vector angle 422c, which is zero-degrees because the vector aligns with the axis of symmetry 120. The resulting measurements include a vector magnitude (distance) and angle of direction, providing a polar format for the data. Though the magnitudes relate a vehicular distance, the magnitude also takes into consideration lateral distances and the longitudinal distance. For further clarity, a longitudinal distance 420d, 422d, and 430d may be considered with relation to traffic congestion level for each of the traffic lanes.

FIG. 5B provides a Cartesian data representation of the vectors of FIG. 5A. In this respect, the polar coordinates for the return signals 420b, 422b, and 430b are translated to longitudinal and latitudinal components. For FIG. 5B, the longitudinal components are normalized to an origin point 441, because different positions of the sensor input devices 102 (see, e.g., FIG. 1) may affect a comparison of the distance components. Accordingly, present traffic lane 402a includes a longitudinal distance component 422d, adjacent traffic lane 402b includes a longitudinal component 430d, and adjacent traffic lane 402c includes a longitudinal component 420d. For the example of FIG. 4, the adjacent traffic lane 402b has a distance D₄₃₀, which is greater than distance D₄₂₂ of present lane 422, and distance D₄₂₀ of the adjacent lane 420d. Because traffic congestion levels may be inversely proportional to a relative longitudinal distance between the vehicle 100 and vehicles 420, 422, and 430, the lowest-congested traffic lane of the example is adjacent lane 402b. In the example of FIG. 5B, the proportional constant k may be “1”, or may be other constant values based on road conditions. For example, congestion determinations may be fine-tuned with a constant k based on road capacity affected by roadway condition (excellent, poor, dirt, hilly, etc).

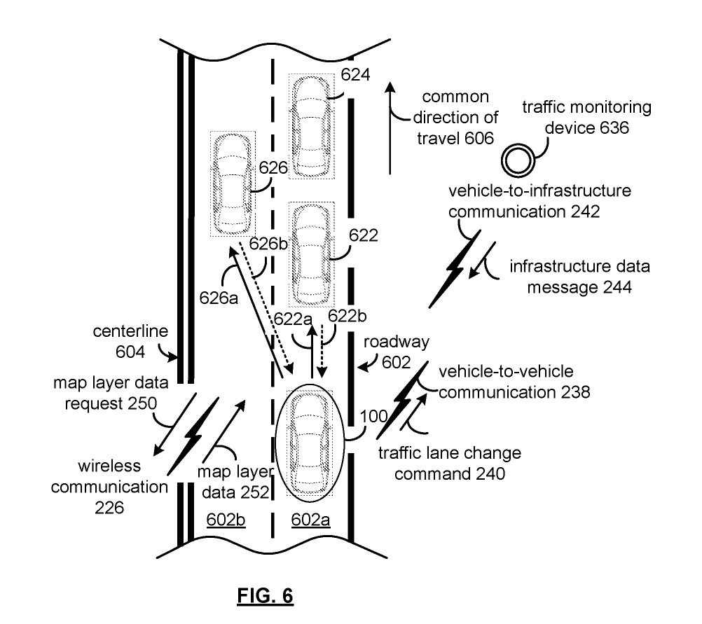

FIG. 6 illustrates another example of traffic lane selection by the vehicle 100. In FIG. 6, a roadway 602 may include a present traffic lane 602a and an adjacent traffic lane 602b in a common direction of travel 606, as may be indicated by centerline 604. The present traffic lane 602a may include the vehicle 100, and other vehicles 622 and 624. The adjacent traffic lane 602b may include other vehicle 626.

In the example of FIG. 6, traffic lane congestion may occur because of vehicles in excess of a bandwidth and/or capacity of the roadway 602, a slow vehicle in a lane (such as present traffic lane 602a), an accident, etc. A traffic congestion condition may be determined by the vehicle 100 based on map layer data 252 received in response to a map layer data request 250 via wireless communication 226, based on information from other vehicles 622, 624, and/or 626 via the vehicle-to-vehicle communication 238, or by the vehicle control unit of the vehicle 100 sensing a reduction in operational speed over a period of time, which also may be referred to as “closing” of the longitudinal distance to vehicle 622, which is ahead of vehicle 100 of present traffic lane 602a. The various forms of data may be considered alone in combination with the others to improve a determination of a traffic congestion condition for the roadway 602.

As shown in FIG. 6, the vehicle control unit of the vehicle 100 determines that the roadway 602 includes multiple traffic lanes 602a and 602b in a common direction of travel 606. This determination may be provided via the wireless communication 226, such as a request and receipt of a Route Network Description File (RNDF) and associated data.

When the traffic congestion condition for the roadway 602 exceeds a threshold, such as “red” or “dark red” data designation from the map layer data request 250, or as may be received from a traffic monitoring device 636 (such as a street pole with camera monitors, proximity sensors, etc) as an infrastructure data message 244 and received over vehicle-to-infrastructure communication 242.

The vehicle control unit of the vehicle 100 operates to identify the present traffic lane 602a of the vehicle 100 in relation to other traffic lanes, which in the example of FIG. 6, is adjacent traffic lane 602b. The vehicle control unit of the vehicle 100 determines traffic congestion level for the each of the traffic lanes 602a and 602b, such as through sensor input devices 102 (see, e.g., FIG. 1). Variation in traffic congestion level among traffic lanes provides an indication of the traffic flow (or relative speed) among each traffic lane.

The sensor input devices 102 may determine traffic lane congestion based on distance to a vehicle ahead of the vehicle 100, which in the present example are vehicles 622 and 626. The sensor input device 102 generates a ranging signal 626a, and receives in response a return signal 626b for vehicle 626. The sensor input device 102 generates a ranging signal 622a, and receives in response a return signal 622b for vehicle 622. Based on a longitudinal distance component of the return signals 622b and 626b, the greatest distance from vehicle 100 is vehicle 626 of the adjacent traffic lane 602b. A lower congestion level may be indicated by a greater distance relative to the vehicle 100, because a congestion level of a traffic lane is inversely proportional to the distance from the vehicle 100.

The vehicle control unit of the vehicle 100, when the lowest-congested traffic lane is other than the present traffic lane 602a, may operate to generate a traffic lane change command 240, which may include identifier data for the adjacent traffic lane having a lower traffic congestion level, which in the present example is adjacent traffic lane 602b. The vehicle control unit of the vehicle 100 transits the traffic lane change command 240 to effect a traffic lane change from the present traffic lane 602a to the adjacent traffic lane 602b. To effect the traffic lane change, the command 240 may be provided to a powertrain control unit 248 (see, e.g., FIG. 2) to produce control signals to powertrain actuators of the vehicle 100. The traffic lane change command 240 may also be transmitted over the vehicle-to-vehicle communication 238 and/or the vehicle-to-infrastructure communication 242 to advise of the status of the vehicle 100 to a traffic monitoring device 636 and/or to the other vehicles 622, 624 and 626.

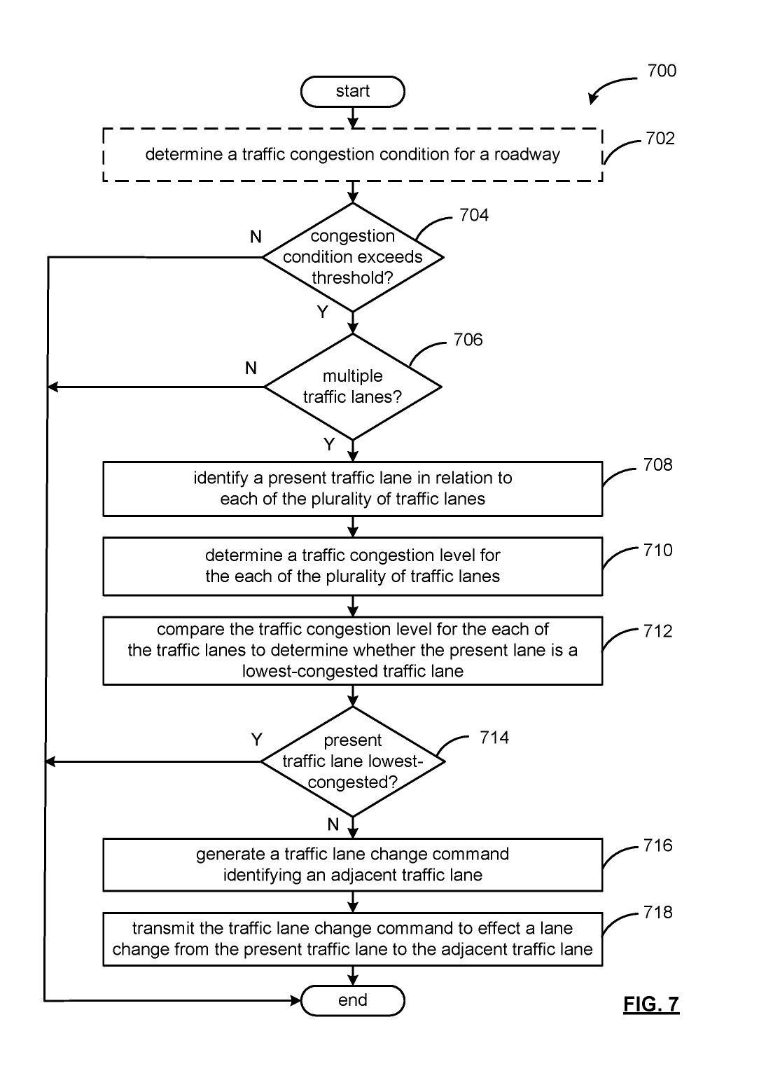

FIG. 7 shows an example process 700 for autonomous traffic lane selection based on traffic lane congestion.

In operation 702, a traffic congestion condition for a roadway is determined. The operation 702 is illustrated as a hashed line because in autonomous operation, vehicle flow of a roadway may be continuously sensed, and readily available to a vehicle control unit of a vehicle.

A traffic congestion condition may be determined on various bases. For example, map layer data, received in response to a map layer data request, may be used to determine a congestion level on the traffic flow for a roadway. Also, the vehicle control unit of the vehicle may monitor a volume of communication via the vehicle-to-vehicle communication, or a traffic control device 440 broadcasts a “stop” indication through an infrastructure data message 244 over a vehicle-to-infrastructure communication 242.

When the traffic congestion condition exceeds a threshold at operation 704, a vehicle control unit of the vehicle may determine at operation 706 whether the roadway includes multiple traffic lanes with travel in a uniform travel direction. When a congestion threshold is not exceeded, the process 700 ends.

When multiple traffic lanes are present at operation 706, vehicles may be distributed in a generally equal density across a roadway to improve traffic flow. In this manner, a “bandwidth” of capacity of the roadway may be placed at the best and optimal usage.

When congestion conditions occur, the roadway distribution of traffic lanes may be assessed at operation 708, and a traffic congestion level for each of the traffic lanes may be assessed at operation 710 as lower and/or lowest traffic congestion levels. With multiple traffic lanes, a present traffic lane of a vehicle in relation to each of the traffic lanes is identified.

A traffic congestion level for each of the traffic lanes 402a, 402b and 402c may be made based on vehicle sensor technology, such as LIDAR, milliwave, etc. On example process to determine a traffic congestion level for a traffic lane may be based on a longitudinal distance from the vehicle 100 to each vehicle ahead in the respective traffic lane, as discussed in detail above with respect to FIG. 4. Generally, congestion traffic levels for a traffic lane is inversely proportional to the distance relative to the sensing vehicle, such as vehicle 100 (see FIG. 1).

A comparison of the traffic congestion level for each lane is made at operation 712, and when the lowest-congested traffic lane is other than the present traffic lane at operation 714, the process 700 may operate to traverse to the lowest-congest traffic lane by generating a traffic lane change command at operation 716, which may include identifier data for adjacent traffic lane having a lower and/or lowest traffic congestion level, and transmit the traffic lane change command at operation 718 to effect the traffic lane change. In the instant example, the powertrain control unit of the vehicle may effect a traffic lane change to the adjacent traffic lane based on the traffic lane change command.

As may be appreciated, the vehicle 100 may operate to broadcast and/or announce the traffic lane change command so that other vehicles may be aware of the maneuver that the vehicle 100 may undertake.

While particular combinations of various functions and features of the present invention have been expressly described herein, other combinations of these features and functions are possible that are not limited by the particular examples disclosed herein are expressly incorporated within the scope of the present invention.

As one of ordinary skill in the art may appreciate, the term “substantially” or “approximately,” as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items range from a difference of a few percent to magnitude differences. As one of ordinary skill in the art may further appreciate, the term “coupled,” as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (that is, where one element is coupled to another element by inference) includes direct and indirect coupling between two elements in the same manner as “coupled.” As one of ordinary skill in the art will further appreciate, the term “compares favorably,” as may be used herein, indicates that a comparison between two or more elements, items, signals, et cetera, provides a desired relationship. For example, when the desired relationship is that a first signal has a greater magnitude than a second signal, a favorable comparison may be achieved when the magnitude of the first signal is greater than that of the second signal, or when the magnitude of the second signal is less than that of the first signal.

As the term “module” is used in the description of the drawings, a module includes a functional block that is implemented in hardware, software, and/or firmware that performs one or more functions such as the processing of an input signal to produce an output signal. As used herein, a module may contain submodules that themselves are modules.

Thus, there has been described herein an apparatus and method, as well as several embodiments including a preferred embodiment, for implementing traffic lane selection for a roadway based on traffic lane congestion.

It will be apparent to those skilled in the art that the disclosed invention may be modified in numerous ways and may assume many embodiments other than the preferred forms specifically set out and described above. Accordingly, it is intended by the appended claims to cover all modifications of the invention that fall within the true spirit and scope of the invention.

The foregoing description relates to what are presently considered to be the most practical embodiments. It is to be understood, however, that the disclosure is not to be limited to these embodiments but, on the contrary, is intended to cover various modifications and equivalent arrangements included within the spirit and scope of the appended claims, which scope is to be accorded the broadest interpretations so as to encompass all such modifications and equivalent structures as is permitted under the law.

What is claimed is:

1. A method in an autonomous vehicle control unit for traffic lane selection from a roadway having a plurality of traffic lanes in a common direction of travel, the method comprising:
identifying a present traffic lane in relation to each of the plurality of traffic lanes;
determining a traffic congestion level for the each of the plurality of traffic lanes;
comparing the traffic congestion level for the each of the plurality of traffic lanes to determine a lowest-congested traffic lane of the plurality of traffic lanes;
when the lowest-congested traffic lane is other than the present traffic lane:
generating a traffic lane change command including identifier data for an adjacent traffic lane having a lower traffic congestion level; and
transmitting the traffic lane change command to effect a traffic lane change from the present traffic lane to the adjacent traffic lane.

2. The method of claim 1, wherein the determining the traffic congestion level for the each of the plurality of traffic lanes comprising:
sensing a vehicle positioned ahead along the common direction of travel; and
determining a distance to the vehicle to produce the traffic congestion level.

3. The method of claim 1, wherein the determining the traffic congestion level for the each of the plurality of traffic lanes comprising:
sensing a vehicle positioned ahead along the common direction of travel; and
detecting a closing of a longitudinal distance to the vehicle; and
determining a rate of the closing of the longitudinal distance to the vehicle to produce the traffic congestion level.

4. The method of claim 1, wherein the transmitting the traffic lane change command further comprising:
transmitting the traffic lane change command to a powertrain control unit; and
broadcasting the traffic lane change command.

5. The method of claim 4, wherein the broadcasting the traffic lane change command comprising:
a vehicle-to-vehicle communication; and
a vehicle-to-infrastructure communication.

6. A method in a vehicle control unit for traffic lane selection of a roadway for an autonomous vehicle operation, the method comprising:
determining a traffic congestion condition for the roadway;
when the traffic congestion condition exceeds a threshold, determining whether the roadway includes a plurality of traffic lanes for travel in a uniform travel direction; and
when the roadway includes the plurality of traffic lanes:
identifying a present traffic lane in relation to each of the plurality of traffic lanes;
determining a traffic congestion level for the each of the plurality of traffic lanes;
comparing the traffic congestion level for the each of the plurality of traffic lanes to determine whether the present traffic lane is a lowest-congested traffic lane of the plurality of traffic lanes; and
when the lowest-congested traffic lane is other than the present traffic lane, traversing the roadway to the lowest-congested traffic lane by:
generating a traffic lane change command identifying an adjacent traffic lane; and
transmitting the traffic lane change command to effect a lane change from the present traffic lane to the adjacent traffic lane.

7. The method of claim 6, further comprising:
when the lowest-congested traffic lane is other than the adjacent traffic lane, again traversing the roadway to the lowest-congested traffic lane by:
generating another traffic lane change command including identifier data for a next adjacent traffic lane; and
transmitting the another traffic lane change command to effect a traffic lane change from the present traffic lane to the next adjacent traffic lane.

8. The method of claim 6, wherein the determining the traffic congestion condition for the roadway comprising:
retrieving location data;
requesting, based on the location data, map layer data including roadway information;
receiving, in response, the map layer data indicating a present traffic speed for the roadway relative to a free-flowing traffic speed; and
processing the map layer data to produce the traffic congestion condition for the roadway.

9. The method of claim 6, wherein the threshold indicates less than a free-flowing traffic speed for the roadway.

10. The method of claim 6, wherein the traffic congestion condition for the roadway being based on sensing vehicle-to-vehicle communication levels.

11. The method of claim 10, wherein the sensing the vehicle-to-vehicle communication levels including sensing a volume of vehicle-to-vehicle communication collisions.

12. The method of claim 6, wherein the determining the traffic congestion condition for the roadway comprising:
receiving a vehicle-to-infrastructure communication message;
retrieving message data from the vehicle-to-infrastructure communication message;
determining a congestion value for the message data; and
assigning the congestion value to the traffic congestion condition.

13. The method of claim 6, wherein the determining whether the roadway includes the plurality of traffic lanes in the uniform travel direction comprising:
retrieving location data;
requesting, based on the location data, map layer data including roadway information data; and
receiving, in response, the map layer data.

14. The method of claim 13, wherein the map layer data comprises a Route Network Description File indicating an amount of the traffic lanes for the roadway.

15. The method of claim 6, wherein the determining whether the roadway includes the plurality of traffic lanes in the uniform travel direction comprising:
receiving vehicle sensor data;
determining roadway features based on the vehicle sensor data;
inferring from the roadway features to infer more than one traffic lane; and
generating an initial estimate of traffic lane geometry.

16. The method of claim 6, wherein the transmitting the traffic lane change command to effect the lane change from the present traffic lane to the adjacent traffic lane further comprising:
transmitting the traffic lane command to a powertrain control unit; and
broadcasting the traffic lane command.

17. A vehicle control unit for traffic lane selection comprising:
a wireless communication interface to service communication with a vehicle network and user equipment of a vehicle user;
a processor coupled to the wireless communication interface, the processor for controlling operations of the vehicle control unit; and
a memory coupled to the processor, the memory for storing data and program instructions used by the processor, the processor configured to execute instructions stored in the memory to:
identify a present traffic lane in relation to each of the plurality of traffic lanes;
determine a traffic congestion level for the each of the plurality of traffic lanes;
compare the traffic congestion level for the each of the plurality of traffic lanes to determine a lowest-congested traffic lane of the plurality of traffic lanes; and
when the lowest-congested traffic lane is other than the present traffic lane:
generate a traffic lane change command including identifier data for an adjacent traffic lane having a lower traffic congestion level; and
transmit the traffic lane change command to effect a traffic lane change from the present traffic lane to the adjacent traffic lane.

18. The vehicle control unit of claim 17, wherein the processor being further configured to execute further instructions stored in the memory to determine the traffic congestion level for the each of the plurality of traffic lanes by:
sensing a vehicle positioned ahead along the common direction of travel; and
determining a distance to the vehicle to produce the traffic congestion level.

19. The vehicle control unit of claim 17, wherein the processor being further configured to execute further instructions stored in the memory to determine the traffic congestion level for the each of the plurality of traffic lanes by:
sensing a vehicle positioned ahead along the common direction of travel; and
detecting a closing of a longitudinal distance to the vehicle; and
determining a rate of the closing of the longitudinal distance to the vehicle to produce the traffic congestion level.

20. The vehicle control unit of claim 17, wherein the processor being further configured to execute further instructions stored in the memory to transmit the traffic lane change command by:
transmitting the traffic lane command to a powertrain control unit; and
broadcasting the traffic lane command.
